(19) United States
(12) Patent Application Publication
(10) Pub. No.: US 2019/0025195 A1
(43) Pub. Date: Jan. 24, 2019

(54) System for high speed measurement of elliptically polarized light and related method

(71) Applicant: Ningbo Molian Materials Technology Inc., Ningbo (CN)

(72) Inventors: Xiao-ping WANG, Shanghai (CN); Liang-yao CHEN, Shanghai (CN); Xiao-dong XIANG, Danville, CA (US)

(73) Assignee: Ningbo Molian Materials Technology Inc., Ningbo (CN)

(21) Appl. No.: 16/041,729

(22) Filed: Jul. 20, 2018

Related U.S. Application Data
(60) Provisional application No. 62/535,760, filed on Jul. 21, 2017.

(51) Int. Cl. G01N 21/21; G01J 4/04; G02B 5/30

(52) U.S. Cl. CPC G01N 21/211; G02B 5/3066; G01J 4/04

(57) ABSTRACT

The present invention provides an apparatus for rapid ellipsometry. The apparatus contains a light source, a polarizer, a sample stage, an integrated polarization analyzer, and a detector assembly. The light emitted by light source is polarized by the polarizer and shines on the sample mounted on sample stage. The light is reflected from the sample surface and passes through the integrated polarization analyzer. The analyzer contains multiple polarizers with different polarization angles from 0 to 180 degrees for transmitting light from the sample. The detector assembly includes multiple detectors corresponding one-to-one with the multiple polarizers, for independently determining the light intensity transmitted by each polarizer. The current invention provides a rapid ellipsometry apparatus that is highly efficient, with the fastest acquisition time down to nanosecond scale for obtaining dynamic parameters of the sample. The current invention also provides a method to rapidly determine the shape of elliptically polarized light.

### BACKGROUND OF THE INVENTION

### Field of the Invention

The present invention generally relates to optical and electronics technologies, and in particular, it relates to methods and apparatus of high speed ellipsometry system and methods.

### Description of Related Art

The rapid development of optical communication technologies rely on the research and development of high performance light waveguides, light switches, light amplifiers, narrow band filter, and other optical components. During research and development of optical components, there is a need for rapid and precise measurement and analysis of optical parameters and optical properties of various optical materials. For optical thin film devices, the rapid and precise measurement of thickness and optical constants of thin films is also required in to control the fabrication process. Thus, there is a need to develop a rapid, precise, and high performance measurement methods and apparatus for measuring optical properties of materials.

Ellipsometry apparatus is an optical measurement apparatus that can measure the optical properties and optical constants of optical materials with high sensitivity. This enables the analyses of material properties in different optical spectral ranges, furthers the understanding of the materials and promote their applications. For example, P.-H. Mao et al, Optics Express 17, 8641 (2009), and Chinese patent publication CN 1664661 disclose a system which combines a integrated polarization analyzer and a two-dimensional CCS detector, which can detect the polarization of the light without any mechanical rotation. This technology can achieve optical parameter measurement with millisecond speed.

However, for dynamic optical parameters where the time scale for dynamic changes is close to nanoseconds, current ellipsometry systems cannot measure such optical properties.

### SUMMARY

To solve the above problems of the current ellipsometry apparatus, the present invention provides an apparatus and method for rapid elliptical polarized light measurement.

In one aspect, the ellipsometry apparatus of the present invention includes a light source, a polarizer, a sample stage, an integrated polarization analyzer, and a detector assembly. The light emitted by the light source is polarized by the polarizer and shines on the sample mounted on sample stage. The light is reflected from the sample surface and input into the integrated polarization analyzer. The integrated polarization analyzer contains multiple polarizers with different polarization angles from 0 to 180 degrees, and the reflected light from the sample is incident on each polarizer. The detector assembly includes multiple detectors, corresponding one-to-one with the multiple polarizers, and configured to determine the light intensity transmitted by the corresponding polarizer.

Preferably, the detector assembly further includes multiple electronic readers coupled to the detectors.

Preferably, the multiple electronic readers correspond one-to-one with the detectors, to independently obtain the signal from the corresponding detectors.

Preferably, a beam expander is located on the optical path between the sample stage and the integrated polarization analyzer. The reflected beam from the sample passes through the beam expander first and then enters the integrated polarization analyzer.

Preferably, a controller is electrically connected to the detector assembly.

Preferably, an optical fiber coupler is connecting to each detector and the corresponding electronic reader.

Preferably, each detector is a photodetector. The maximum acquisition frequency is 40 GHz, and the minimum acquisition time is 25 ps.

Preferably, the electronic reader is an oscilloscope.

The present invention provides a method for rapid elliptical polarized light measurement. The steps are as follows:

Step S1: The light is emitted from a light source. It passes through the polarizer and becomes linear polarized light. Then the polarized light is incident on the sample and is reflected by the sample. Step S2: The reflected light is input to the integrated polarization analyzer, which contains multiple polarizers along different orientations. The reflected light becomes multiple linear polarized beams with different polarization directions. Step S3: Multiple detectors are provided, with a one-to-one correspondence with the multiple polarizers. Each linear polarized beam output by a polarizer is detected by one corresponding detector, and converted to electrical signal.

Preferably, the method also includes Step S4: The electrical signal from each detector is read by an electronic reader, and is displayed and/or transmitted to the controller.

The controller analyzes the acquired data to determine the thickness, optical constants, etc. of the sample.

Compared to conventional ellipsometry, the system for rapid elliptical polarized light measurement of the present invention has the following advantages:

1. There is one detector connected to each polarizer in the integrated polarization analyzer. Each detector measures one polarization part of the elliptical light transmitted by one polarizer. According to this design, the measurement efficiency is high and the measuring speed can be as fast as nanoseconds.

2. There is one electronic reader connected to each detector, so each electronic reader only needs to read the optical signal from the corresponding detector and convert it to electrical signal. This increases the signal conversion speed, making the overall reading speed of the system as fast as nanosecond, achieving dynamic measurement of many optical properties.

3. There is a beam expander located between the sample stage and the integrated polarization analyzer. By using the beam expander to expand the laser beam size and also reduce the divergence angle of the beam, the expanded beam can be better collected by the integrated polarization analyzer.

The present invention also provide a method for rapid elliptical polarized light measurement having the above advantages.

### BRIEF DESCRIPTION OF THE DRAWINGS

FIG. 1 is a schematic diagram of an ellipsometry apparatus for rapid elliptical polarized light measurement according to an embodiment of the present invention.

FIG. 2 is a schematic diagram of the sample stage in the ellipsometry apparatus.

FIG. 3A is a schematic diagram of the integrated polarization analyzer and detectors in the ellipsometry apparatus.

FIG. 3B is a schematic diagram of the orientation of polarizers in the integrated polarization analyzer.

FIG. 4 is a schematic diagram of the connection between the detectors and the controller in the ellipsometry apparatus.

FIG. 5 is another schematic diagram of the connection between the detectors and the controller in the ellipsometry apparatus.

FIG. 6 is a schematic diagram of another apparatus for rapid elliptical polarized light measurement according to an embodiment of the present invention.

FIG. 7 is a flow chart of a method for rapid elliptical polarized light measurement according to an embodiment of the present invention.

### DETAILED DESCRIPTION OF PREFERRED EMBODIMENTS

For better understanding of the purpose, technical scheme and advantages of the present invention, embodiments of the present invention are described below with reference to the drawings. These embodiments are explanatory and not limiting.

It should be noted that in the descriptions, when one component is said to be provided or disposed in or on another component, the former component may be connected to the other component of be contained in the other component. Also, terms such as perpendicular, horizontal, up, down, etc. are explanatory and not limiting.

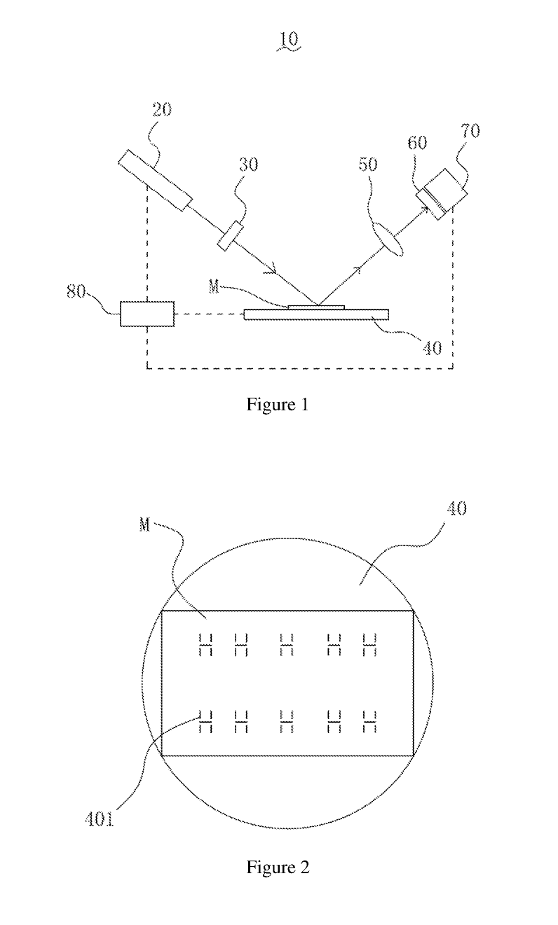

As shown in FIG. 1, the structure of a first embodiment of the ellipsometry apparatus 10 contains a light source 20, a polarizer 30, a sample stage 40, a beam expander 50, an integrated polarization analyzer 60, a detector assembly 70 and a controller 80.

The light source 20, the polarizer 30, the sample stage 40, the beam expander 50, the integrated polarization analyzer 60, and the detector assembly 70 are arranged sequentially along the optical path. The light source 20, the sample stage 40, the integrated polarization analyzer 60, and the detector assembly 70 are electrically connected to the controller 80. The controller 80 may control the various other components using software, such as Labview, to acquire and analysis data automatically.

As shown in FIG. 2, the sample M is mounted on the sample stage 40. There are several vacuum suction grooves 401 on the surface of the sample stage 40. When the sample M is placed over the suction grooves 401, and a vacuum pump (not shown) connected to the suction grooves 401 is turned on, the negative pressure of the suction grooves 401 secure the sample on the sample stage 40. To enhance the suction power, the contact surface between the suction grooves 401 and the sample M may be made into a ring shape, a double ring shape, an H shape, or a star shape to increase the contact surface between the suction grooves 401 and the sample M.

There is a thermostat (not shown) on the sample stage 40 for measuring the ambient temperature around the sample M on the sample stage 40 and can control the ambient temperature. Thus, the ambient temperature around the sample M can be maintained at a constant, which can eliminate interference of temperature variation on the measurement result, and can also detect the optical properties of the sample M as a function of temperature.

The light source 20 is a laser. Preferably, a He—Ne gas laser with wavelength 632.8 nm is used. Preferably, the polarizer 30 is a Glan-Foucault polarizer made of calcite.

The light emitted by the light source 20 passes through the polarizer 30 and becomes linear polarized light and is incident on the sample M. The incident polarized light on the sample M is reflected from the sample surface. The reflected polarized light is expanded after passing through the beam expander 50. It then passes through the integrated polarization analyzer 60 and the multiple linear polarized beams after the integrated polarization analyzer are detected by the detector assembly 70. The detected signals are transferred to controller 80 for analysis to obtain optical constants of the sample.

The beam expander 50 is located between the sample stage 40 and the integrated polarization analyzer 60. It expands the diameter of the beam and reduces the divergence angle of the beam to facilitate collection by the integrated polarization analyzer. Preferably, the expansion ratio of the beam expander 50 is approximately 5 to 10.

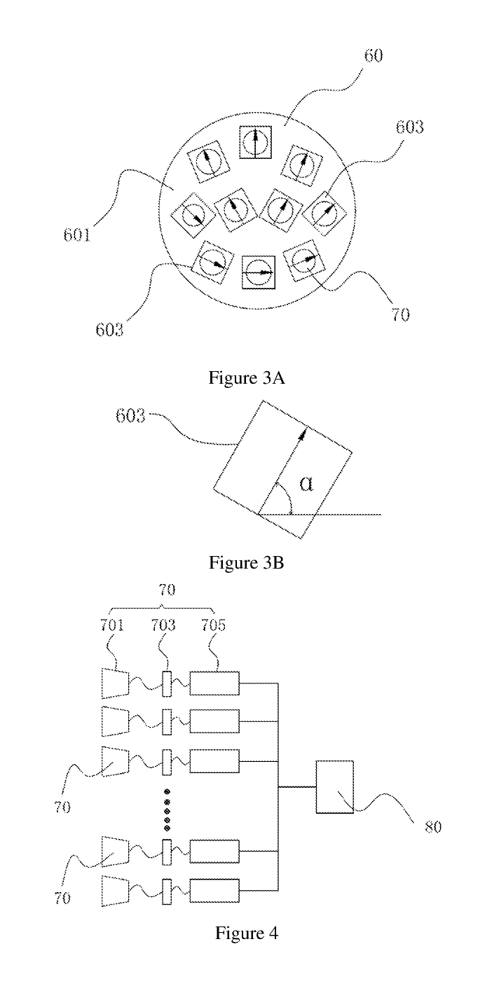

Referring to FIGS. 3A-3B and 4, the integrated polarization analyzer 60 including a frame 601 and a plurality of polarizers 603. In one example, the frame 601 is made of aluminum with diameter 9.5 mm and thickness 2 mm. There are N polarizers 603 mounted on the frame 601, where N is a positive integer, and preferably 10. The polarization orientations of the polarizers are indicated by their orientation angles α, distributed from 0 to 180 degrees. The orientation angles α may be distributed uniformly or non-uniformly.

More specifically, the integrated polarization analyzer 60 has N through holes (e.g. square through holes) on the frame 601, at different orientations distributed approximately uniformly between 0 to 180 degrees. The polarizers have approximately the same size as the through holes, and are placed into the through holes according to the polarization direction of the polarizers, so that the polarization directions of the polarizers are different and are distributed approximately uniformly between 0 to 180 degrees. As a result, the output light after the integrated polarization analyzer 60 have different polarization states.

The number of polarizers 603 determines the number of data points of different linear polarizations that can be obtained at once using the integrated polarization analyzer 60. The orientation angles α of polarizers 603 may be adjusted to determine the polarization state of each polarizer 603. By uniformly distributing the orientation angles of the multiple polarizers 603, data for different orientation angles can be obtained. The angular distance between polarizers 603 is determined by the number of polarizers used; when more polarizers 603 are used, the angular distance between polarizers 603 is smaller, and vice versa.

Behind each polarizer 603, there is an independent detector 703, for detecting the light intensity that passed through the corresponding polarizer 603. The light intensity is converted to an electrical signal and transferred to the controlled 80. The controller 80 processes the data from the detector assembly 70 to obtain one or more optical properties of the sample M.

The detector assembly 70 contains multiple detectors 703 and multiple electronic readers 705. A Newport Photodetectors 1014 photoelectric detector is used as detector 703 in one example. Its acquisition frequency is 40 GHz, means the acquisition time could be 25 ps, suitable for detecting high speed dynamic data from the polarizers 603 which is in the nanosecond scale.

Each electronic reader 705 can readout the signal from the detector 703 and display the data and/or transmit the data to the controller 80. Preferably, an oscilloscope having a sample rage of 10 GHz is used as the electronic reader 705. The electronic reader 705 is connected to the detector 703, and can increase the signal measuring speed to 1 GHz.

Because each polarizer 603 can only pass polarized light in a particular direction, by providing an independent detector 703 for each polarizer 603, the detector 703 only needs to detect a single polarized light that has passed through one polarizer, resulting in high efficiency in optical data sampling that can measure the high speed dynamic data from the polarizer 603 which is on the nanosecond scale.

Also, the detector 703 are photoelectric detectors, which can better detect the optical signals from the polarizer 603, and can measure the high speed dynamic data from the polarizer 603 which is on the nanosecond scale.

Further, by providing an electronic reader 705 for each detector 703, i.e. a one to one correspondence between the electronic readers 705 and the detectors 703, each electronic reader 705 only needs to read out the data detected by the corresponding detector 703, and display and/or transmit the electrical signal corresponding to the optical signal, high efficiency conversion from optical signal to electrical signal is achieved, so that nanosecond measurement speed of the overall ellipsometry apparatus can be achieved. This enables rapid and complete measurement of the shape of the elliptical polarized light, which in turn enables dynamic measurement of a large number of physical properties of materials.

In this embodiment, each detector 703 is coupled to the corresponding polarizer 603 via an optical fiber coupler 701, to collect the optical signal from the polarizer 603. An optical fiber coupler 701 and its corresponding detector 703 and electronic reader 705 form a detector channel, to detect the optical signal from the corresponding polarizer 603.

It should be understood that a number of controllers 708 can also be provided in a one-to-one correspondence with the electronic readers 705, to process the electrical signal from the electronic reader 705.

Using this embodiment, it is possible to determine the elliptical polarized light in nanosecond. Then the optical constants of materials can be determined in nanosecond, which can be widely used in thin film growth field, such as semiconductor industry.

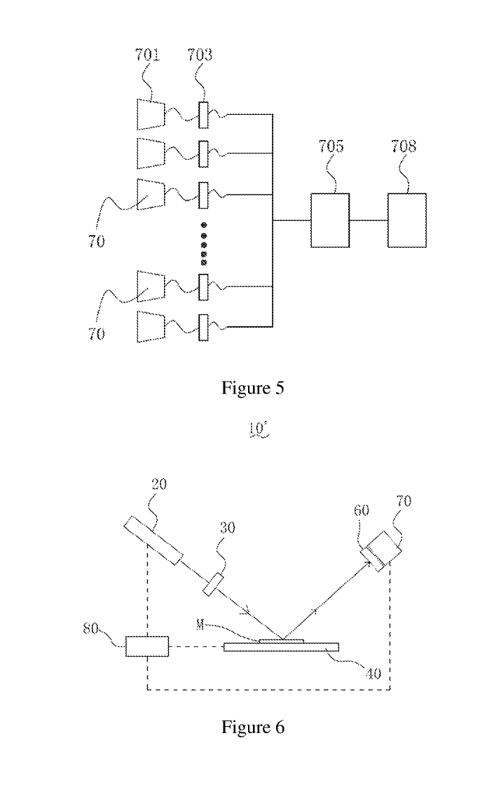

An alternative embodiment is shown in FIG. 5. Different from the first embodiment described earlier, the electrical reader 705 and the detector 703 is not connected one-to-one. Instead, multiple detectors 703 share one, two or more electrical readers 705, and the electronic readers 705 are connected to controllers 708. The controller 708 may have a one-to-one correspondence with the multiple electronic readers 705, or a non one-to-one correspondence. In this case, powerful electronic readers 705 are required to satisfy the reading speed.

Another alternative embodiment of an ellipsometry apparatus 10′ is shown in FIG. 6. Different from the first embodiment described earlier, the ellipsometry apparatus does not have a beam expander 50. The light from the light source 20 passes through the polarizer 20 to be incident on the sample M on the sample stage 40. The light reflected by the sample M is incident in the integrated polarization analyzer 60. The detector assembly 70 detects the polarized light signals and converts them to electrical signals which is transmitted to the controller 80. The controller 80 processes the electrical signal.

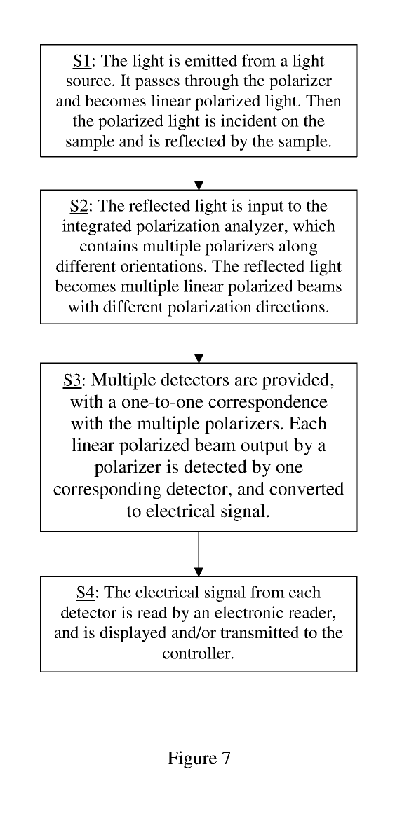

FIG. 7 shows the flow chart of the method for rapid elliptical polarized light measurement. The method includes the following steps:

Step S1: The light emitted by the light source passes through the polarizer and becomes linear polarized light. Then the light is incident on the sample and is reflected from the sample surface.

Step S2: The reflected light is incident on the integrated polarization analyzer, which contains multiple polarizers along different orientations. The reflected light becomes multiple small linear polarized beams with different polarization direction.

Step S3: Multiple detects are provided in a one-to-one correspondence with the multiple polarizers of the integrated polarization analyzer. The optical signal of each linear polarized beam from one polarizer is detected by one detector and converted to an electrical signal.

Step S4: Each electrical signal from one detector is read by one electronic reader, and is displayed and/or transmitted to the controller.

The controller analyzes the acquired data to determine the thickness, optical constants, etc. of the sample.

Further, a step S11 may be performed between steps S1 and S2:

Step S11: The polarized light reflected from the sample M is expanded by the beam expander before entering the integrated polarization analyzer.

Preferably, the light source in step S1 is a He—Ne gas laser with wavelength 632.8 nm.

Preferably, each detector in step S2 is a photodetector. The maximum acquisition frequency is 40 GHz, which means 25 ps acquisition speed.

Preferably, in step S4, the electronic readers have a one-to-one correspondence with the detectors, to independently read out the signal detected by each detector.

Compared to conventional ellipsometry, the system 10 for rapid elliptical polarized light measurement according to embodiments of the present invention has the following advantages:

1. There is one detector connected to each polarizer in the integrated polarization analyzer. Each detector measures one polarization part of the elliptical light transmitted by one polarizer. Thus, the measurement efficiency is high and the measuring speed of dynamic parameters can be as fast as nanosecond.

2. There is one electronic reader connected to each detector, so each electronic reader only needs to read the optical signal from the corresponding detector and convert it to electrical signal. This increases the signal conversion speed, making the overall reading speed of the system as fast as nanosecond, achieving dynamic measurement of many optical properties.

3. There is a beam expander located between the sample stage and the integrated polarization analyzer. By using the beam expander to expand the laser beam size and also reduce the divergence angle of the beam, the expanded beam can be better collected by the integrated polarization analyzer.

The method for rapid elliptical polarized light measurement according to other embodiments of the present invention has the above advantages.

Various modification and variations can be made in the apparatus and method of the present invention without departing from the spirit or scope of the invention. Thus, it is intended that the present invention cover modifications and variations that come within the scope of the appended claims and their equivalents.

What is claimed is:

1. A rapid ellipsometry apparatus, comprising:
a light source;
a first polarizer disposed to polarize a light emitted by the light source;
a sample stage configured to hold a sample being measured, wherein the sample receives the polarized light from the polarizer and reflects it;
an integrated polarization analyzer, wherein the analyzer includes multiple second polarizers with different orientation angles distributed from 0 to 180 degrees, configured to receive the reflected polarized light from the sample; and
a detector assembly, including multiple detectors which correspond one-to-one with the multiple second polarizers, configured to independently determine light intensity outputted by the corresponding second polarizers.

2. The rapid ellipsometry apparatus of claim 1, wherein the detector assembly further includes multiple electronic readers coupled to the multiple detectors.

3. The rapid ellipsometry apparatus of claim 2, wherein the multiple electronic readers correspond one-to-one with the multiple detectors and are configured to independently obtain electrical signals from the corresponding detectors.

4. The rapid ellipsometry apparatus of claim 1, further comprising a beam expander disposed on an optical path between the sample stage and the integrated polarization analyzer, configured to expand a light beam reflected from the sample before the light is input to the integrated polarization analyzer.

5. The rapid ellipsometry apparatus of claim 1, further comprising a controller coupled to the detector assembly.

6. The rapid ellipsometry apparatus of claim 5, further comprising multiple optical fiber couplers coupled to the detectors and the electronic readers.

7. The rapid ellipsometry apparatus of claim 1, wherein each detector is a photodetector with a maximum acquisition frequency of 40 GHz and a minimum acquisition time of 25 ps.

8. The rapid ellipsometry apparatus of claim 1, wherein the electronic readers are oscilloscopes.

9. A method for rapid elliptical polarized light measurement, comprising:
Step S1: emitting a light by a light source, passing the light through a polarizer to generate a linear polarized light, shining the light to a sample, and the sample reflecting the polarized light;
Step S2: inputting the reflected light to an integrated polarization analyzer, which including multiple second polarizers arranged along different polarization orientations, the multiple second polarizers receiving the reflected light and outputting multiple linear polarized beams with different polarization directions;
Step S3: using multiple detectors which correspond one-to-one with the multiple second polarizers of the integrated polarization analyzer, detecting the multiple polarized beams from the multiple second polarizers and converting light signal to electrical signals.

10. The method for rapid elliptical polarized light measurement of claim 9, further comprising:
Step S4: using electronic readers, reading out the electrical signals from the detectors, and displaying the read out signals and/or transmitting the read out signals to a controller.
